(19) United States
(12) Patent Application Publication
(10) Pub. No.: US 2005/0129111 A1
(43) Pub. Date: Jun. 16, 2005

(54) Transform-domain video editing

(75) Inventors: Ragip Kurceren, Carrollton, TX (US); Fehmi Chebil, Irving, TX (US); Asad Islam, Richardson, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/737,184

(22) Filed: Dec. 16, 2003

(51) Int. Cl. H04N 7/12

(52) U.S. Cl. 375/240.03; 375/240.18

(57) ABSTRACT

A method and device for editing a video sequence while the sequence is in a compressed format. In order to achieve a video effect, editing data indicative of the video effect is applied to residual data from a compressed bitstream. The residual data can be residual error data, transformed residual error data, quantized transformed residual error data or coded, quantized, transformed residual error data. The video effects include fading-in to a color or to a set of colors, fading-out from a color or a set of color, or fading-in from color components in color video frames to color components in monochrome video frames. The editing operations can be multiplication or addition or both.

### FIELD OF THE INVENTION

The present invention relates generally to video coding and, more particularly, to video editing.

### BACKGROUND OF THE INVENTION

Digital video cameras are increasingly spreading among the masses. Many of the latest mobile phones are equipped with video cameras offering users the capability to shoot video clips and send them over wireless networks.

Digital video sequences are very large in file size. Even a short video sequence is composed of tens of images. As a result, video is usually saved and/or transferred in compressed form. There are several video-coding techniques, which can be used for that purpose. MPEG-4 and H.263 are the most widely used standard compression formats suitable for wireless cellular environments.

To allow users to generate quality video at their terminals, it is imperative to provide video editing capabilities to electronic devices, such as mobile phones, communicators and PDAs, that are equipped with a video camera. Video editing is the process of modifying available video sequences into a new video sequence. Video editing tools enable users to apply a set of effects on their video clips aiming to produce a functionally and aesthetically better representation of their video. To apply video editing effects on video sequences, several commercial products exist. However, these software products are targeted mainly for the PC platform.

Since processing power, storage and memory constraints are not an issue in the PC platform these days, the techniques utilized in such video-editing products operate on the video sequences mostly in their raw formats in the spatial domain. In other words, the compressed video is first decoded, the editing effects are then introduced in the spatial domain, and finally the video is encoded again. This is known as spatial domain video editing operation.

The above scheme cannot be applied on devices, such as mobile phones, with low resources in processing power, storage space, available memory and battery power. Decoding a video sequence and re-encoding it are costly operations that take a long time and consume a lot of battery power.

In prior art, video effects are performed in the spatial domain. More specifically, the video clip is first decompressed and then the video special effects are performed. Finally, the resulting image sequences are re-encoded. The major disadvantage of this approach is that it is significantly computationally intensive, especially the encoding part.

For illustration purposes, let us consider the operations performed for introducing fading-in and fading-out effects to a video clip. Fade-in refers to the case where the pixels in an image fade to a specific set of colors, for instance they get progressively black. Fade-out refers to the case where the pixels in an image fade out from a specific set of colors such as they start to appear from a complete white frame. These are two of the most widely used special effects in video editing.

To achieve these effects in the spatial domain, once the video is fully decoded, the following operation is performed:
\tilde{V}(x,y,t)=α(x,y,t)V(x,y,t)+β(x,y,t) (1)
Where V(x,y,t) is the decoded video sequence, \tilde{V}(x,y,t) is the edited video, α(x,y,t) and β(x,y,t) represent the editing effects to be introduced. Here x, y are the spatial coordinates of the pixels in the frames and t is the temporal axis.

In the case of fading a sequence to a particular color C, α(x,y,t), for example, can be set to

$$α ( x , y , t ) = \frac{C}{V ( x , y , t )} . \qquad ( 2 )$$

Other effects, as transitionally reaching C can be expressed in equation (1).

The modifications on the pixels in the spatial domain can be applied in the various color components of the video sequence depending on the desired effect. The modified sequence is then fed to the video encoder for compression.

To speed up these operations, an algorithm has been presented in Meng et al. (“CVEPS—A Compressed Video Editing and Parsing System”, Proceeding/ACM Multimedia 1996, Boston. pp. 43-53). The algorithm suggests a method of performing the operation in equation (2) at the DCT level by multiplying the DC coefficient of the 8 by 8 DCT blocks by a constant value a that would make the intensities of the pixel fade to a particular color C.

Most of the prior solutions operate in the spatial domain, which is costly in computational and memory requirements. Spatial domain operations require full decoding and encoding of the edited sequences. The speed-ups suggested in Meng et al. are, in fact, an approximation of performing a single specific editing effect at the compressed domain level, i.e., the fading-in to a particular color.

In order to perform efficiently, video compression techniques exploit spatial redundancy in the frames forming the video. First, the frame data is transformed to another domain, such as the Discrete Cosine Transform (DCT) domain, to decorrelate it. The transformed data is then quantized and entropy coded.

In addition, the compression techniques exploit the temporal correlation between the frames: when coding a frame, utilizing the previous, and sometimes the future, frames(s) offers a significant reduction in the amount of data to compress.

The information representing the changes in areas of a frame can be sufficient to represent a consecutive frame. This is called prediction and the frames coded in this way are called predicted (P) frames or Inter frames. As the prediction cannot be 100% accurate (unless the changes undergone are described in every pixel), a residual frame representing the errors is also used to compensate the prediction procedure.

The prediction information is usually represented as vectors describing the displacement of objects in the frames. These vectors are called motion vectors. The procedure to estimate these vectors is called motion estimation. The usage of these vectors to retrieve frames is known as motion compensation.

Prediction is often applied on blocks within a frame. The block sizes vary for different algorithms (e.g. 8×8 or 16×16 pixels, or 2n×2m pixels with n and m being positive integers). Some blocks change significantly between frames, to the point that it is better to send all the block data independently from any prior information, i.e. without prediction. These blocks are called Intra blocks.

In video sequences there are frames, which are fully coded in Intra mode. For example, the first frame of the sequence is fully coded in Intra mode, because it cannot be predicted. Frames that are significantly different from previous ones, such as when there is a scene change, are also coded in Intra mode. The choice of the coding mode is made by the video encoder. FIGS. 1 and 2 illustrate a typical video encoder 410 and decoder 420 respectively.

The decoder 420 operates on a multiplexed video bit-stream (includes video and audio), which is demultiplexed to obtain the compressed video frames. The compressed data comprises entropy-coded-quantized prediction error transform coefficients, coded motion vectors and macro block type information. The decoded quantized transform coefficients c(x,y,t), where x,y are the coordinates of the coefficient and t stands for time, are inverse quantized to obtain transform coefficients d(x,y,t) according to the following relation:
d(x,y,t)=Q⁻¹(c(x,y,t)) (3)
where Q⁻¹ is the inverse quantization operation. In the case of scalar quantization, equation (3) becomes
d(x,y,t)=QPc(x,y,t) (4)
where QP is the quantization parameter. In the inverse transform block, the transform coefficients are subject to an inverse transform to obtain the prediction error E_{c}(x,y,t):
E_{c}(x,y,t)=T⁻¹(d(x,y,t)) (5)
where T⁻¹ is the inverse transform operation, which is the inverse DCT in most compression techniques.

If the block of data is an intra-type macro block, the pixels of the block are equal to E_{c}(x,y,t). In fact, as explained previously, there is no prediction, i.e.:
R(x,y,t)=E_{c}(x,y,t) (6)
If the block of data is an inter-type macro block, the pixels of the block are reconstructed by finding the predicted pixel positions using the received motion vectors (Δₓ, Δ_{y}) on the reference frame R(x,y,t−1) retrieved from the frame memory. The obtained predicted frame is:
P(x,y,t)=R(x+Δₓ,y+Δ_{y},t−1) (7)
The reconstructed frame is
R(x,y,t)=P(x,y,t)+E_{c}(x,y,t) (8)
As given by equation (1), the spatial domain representation of an editing operation is:
\tilde{V}(x,y,t)=α(x,y,t)V(x,y,t)+β(x,y,t).

### SUMMARY OF THE INVENTION

The present invention performs editing operations on video sequences while they are still in compressed format. This technique significantly reduces the complexity requirements and achieves important speed-up with respect to the prior arts. The editing technique represents a platform for several editing operations such as fading-in to a color or to a set of color, fading-out from a color or from a set of colors, fading-in from color components in color video frames to color components in monochrome video frames, and the inverse procedure of regaining the original space.

According to the first aspect of the present invention, there is provided a method of editing a bitstream carrying video data indicative of a video sequence, wherein the video data comprises residual data in the video sequence. The method comprises:
obtaining the residual data from the bitstream; and
modifying the residual data in a transform domain for providing further data in a modified bitstream in order to achieve a video effect.

According to the present invention, the residual data can be residual error data, transformed residual error data, quantized, transformed residual error data or coded, quantized, transformed residual error data.

According to the second aspect of the present invention, there is provided a video editing device for use in editing a bitstream carrying video data indicative of a video sequence, wherein the video data comprises residual data in the video sequence. The device comprises:
a first module for obtaining an error signal indicative of the residual data in transform domain from the bitstream;
a second module, responsive to the error signal, for combining an editing data indicative of an editing effect with the error signal for providing a modified bitstream.

According to the present invention, the bitstream comprises a compressed bitstream, and the first module comprises an inverse quantization module for providing a plurality of transform coefficients containing the residual data.

According to the present invention, the editing data can be applied to the transform coefficients for providing a plurality of edited transform coefficients in the compressed domain, through multiplication or addition or both.

The editing data can also be applied to the quantization parameters containing residual data.

According to the third aspect of the present invention, there is provided an electronic device, which comprises:
a first module, responsive to video data indicative of a video sequence, for providing a bitstream indicative of the video data, wherein the video data comprises residual data; and
a second module, responsive to the bitstream, for combining editing data indicative of an editing effect with the error signal in transform domain for providing a modified bitstream.

According to the present invention, the bitstream comprises a compressed bitstream, and the second module comprises an inverse quantization module for providing a plurality of transform coefficients comprising the error data.

The electronic device further comprises an electronic camera for providing a signal indicative of the video data, and/or a receiver for receiving a signal indicative of the video data.

The electronic device may comprise a decoder, responsive to the modified bitstream, for providing a video signal indicative of decoded video, and/or a storage medium for storing a video signal indicative of the modified bitstream.

The electronic device may comprise a transmitter for transmitting the modified bitstream.

According to the fourth aspect of the present invention, there is provided a software program for use in a video editing device for editing a bitstream carrying video data indicative of a video sequence in order to achieve a video effect, wherein the video data comprises residual data in the video sequence. The software program comprises:
a first code for providing editing data indicative of the video effect; and
a second code for applying the editing data to the residual data in a transform domain for providing a further data in the bitstream, wherein the second code may comprise a multiplication and a summing operation.

The present invention will become apparent upon reading the description taken in conjunction with FIGS. 4 to 11.

### BRIEF DESCRIPTION OF THE DRAWINGS

FIG. 1 is a block diagram illustrating a prior art video encoder process.

FIG. 2 is a block diagram illustrating a prior art video decoder process.

FIG. 3 is a schematic representation showing a typical video-editing channel.

FIG. 4 is a block diagram illustrating an embodiment of the compressed domain approach to fade-in and fade-out effects for Intra frames/macro blocks, according to the present invention.

FIG. 5 is a block diagram illustrating another embodiment of the compressed domain approach to fade-in and fade-out effects for Intra frames/macro blocks, according to the present invention.

FIG. 6 is a block diagram illustrating an embodiment of the compressed domain approach to fade-in and fade-out effects for Inter frames/macro blocks, according to the present invention.

FIG. 7 is a block diagram showing an expanded video encoder, which can be used for compressed-domain video editing, according to the present invention.

FIG. 8 is a block diagram showing an expanded video decoder, which can be used for compressed-domain video editing, according to the present invention.

FIG. 9 is a block diagram showing another expanded video decoder, which can be used for compressed domain video editing, according to the present invention.

FIG. 10a is a block diagram showing an electronic device having a compressed-domain video editing device, according to the present invention.

FIG. 10b is a block diagram showing another electronic device having a compressed-domain video editing device, according to the present invention.

FIG. 10c is a block diagram showing yet another electronic device having a compressed-domain video editing device, according to the present invention.

FIG. 10d is a block diagram showing still another electronic device having a compressed-domain video editing device, according to the present invention.

FIG. 11 is a schematic representation showing the software programs for providing the editing effects.

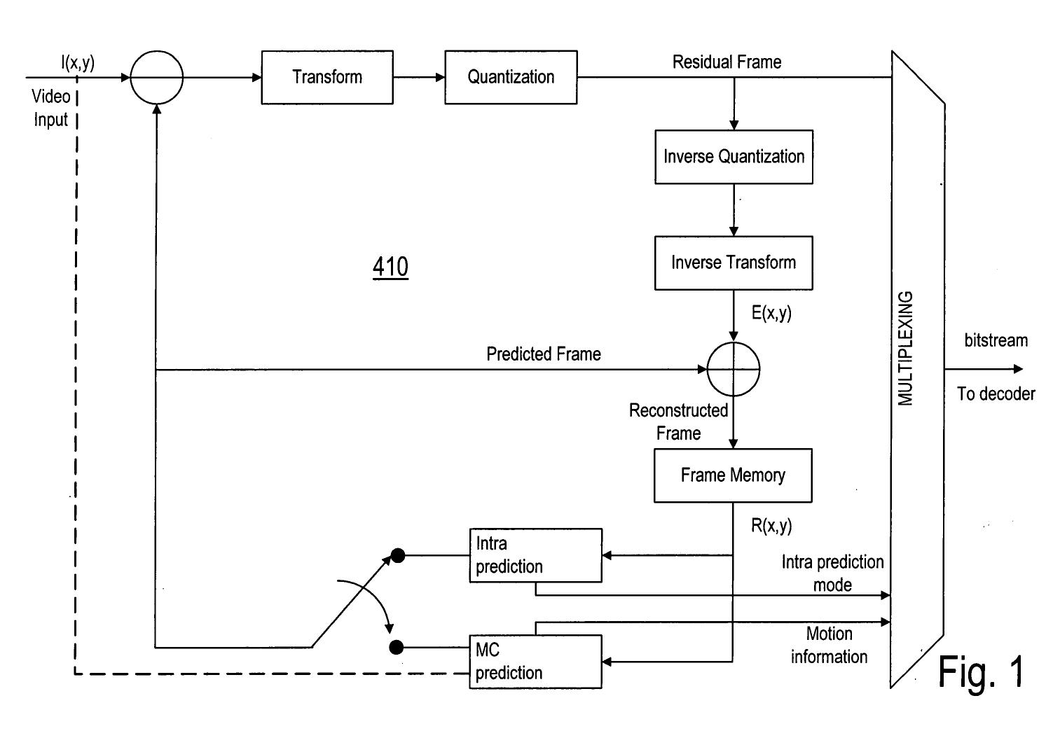

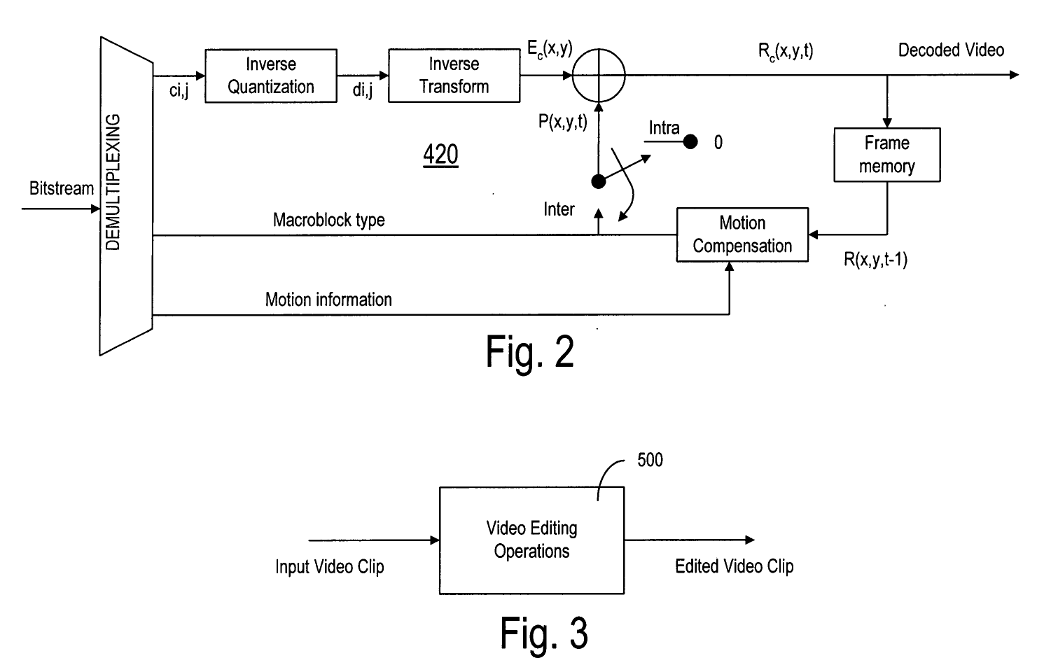

### DETAILED DESCRIPTION OF THE INVENTION

In the present invention, video sequence editing operation is carried out in the compressed domain to achieve the desired editing effects, with minimum complexity, starting at a frame (at time t), and offering the possibility of changing the effect including regaining the original clip.

Let's consider that the editing operation happens in a channel at one of its terminals where editing is taking place on a clip. The edited video is received at another terminal, as shown in FIG. 3. The component between the input video clip and the received terminal is a video editing channel 500 for carrying out the video editing operations. Let the video editing operations start at time t=t₀. To add effects on the video clip, we modify the bitstream starting from that time.

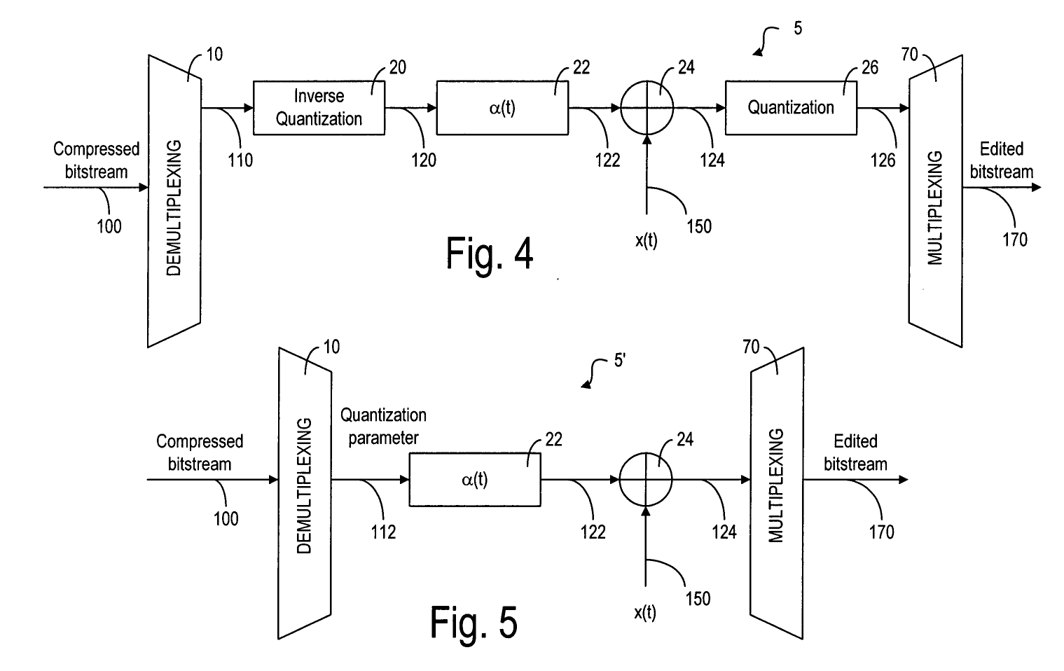

As mentioned earlier there are two types of macro blocks. Looking at the first type—the Intra macro blocks, their reconstruction is obtained independently from blocks at a different time (we are dropping all advanced intra predictions, which take place in the same frame). Therefore, performing the editing operation of equation (1) requires the modification of residual or error data E_{c}(x,y). Plugging equation (5) in equation (1) gives:
\tilde{E}ₑ(x,y,t)=α(x,y,t)E_{c}(x,y,t)+β(x,y,t) (9) [symbol]
~E_{c}(x,y,t)=α(x,y,t)T⁻¹(d(x,y,t))+β(x,y,t) (10)
If the transform used is orthogonal and spanning the vector space it's applied to, as the 8×8 DCT is for [symbol] ⁸× [symbol] ⁸, equation (11) can be written as:
\tilde{E}_{c}(x,y,t)=T⁻¹(Ω(x,y,t)\mathring{×}d(x,y,t)+χ(x,y,t)) (11)
where Ω(x,y,t)=T(α(x,y,t)), χ(x,y,t)=T(β(x,y,t)) and \mathring{×} represents the DCT domain convolution (see Shen et al. “DCT Convolution and Its Application in Compressed Domain”, IEEE Transaction on Circuits and Systems for Video Technology, Vol.8, December 1998). Without loss of generality, we assume that α(x,y,t) is applied on block basis and α(x,y,t) is constant for the block, hence \mathring{×} becomes a multiplication and equation (11) is written as:
\tilde{E}_{c}(x,y,t)=T⁻¹(α(t)d(x,y,t)+χ(x,y,t)) (12)
Equation (12) can be re-written as:
\tilde{E}_{c}(x,y,t)=T⁻¹(\tilde{d}_{c}(x,y,t)) (13)
where,
\tilde{d}_{c}(x,y,t)=α(t)d(x,y,t)+χ(x,y,t) (14)
represents the edited transform coefficients d(x,y,t) in the compressed DCT domain. FIG. 4 shows how to add the editing effect in the transform domain in an editing module 5, according to the present invention.

As shown in FIG. 4, a demultiplexer 10 is used to obtain decoded quantized transform coefficients c(x,y,t) 110 from the multiplexed video bitstream 100. An inverse quantizer 20 is used to obtain the transform coefficients d(x,y,t) 120. A certain editing effect α(x,y,t) is introduced in block 22 to obtain part of the edited transform coefficients α(x,y,t)d(x,y,t) 122 in the compressed DCT domain. A summer device 24 is then used to add an additional editing effect 150 in the transform domain, or χ(x,y,t)=T(β(x,y,t)). After summing, the edited transform coefficients d(x,y,t) 124 in the compressed DCT domain are obtained. After being re-quantized by a quantizer 26, the edited transformed coefficients become edited, decoded quantized transform coeffients 126. These modified coefficients are then entropy coded by a multiplexer 70 as an edited bistream 170.

In case the quantization utilized is scalar and when β(x,y,t) is zero, equation (14) can be written as:
\tilde{d}_{c}(x,y,t)=QPa(t)c(x,y,t) (15)
which is equivalent to simply modifying the quantization parameters, i.e., \tilde{Q}P=QPα(t), thereby eliminating the need for inverse quantization and requantization operations. As shown in FIG. 5, the editing effect block 22 directly modifies the quantization parameters 112 for obtaining the edited transform coefficients 122. Again, the modified coefficients 124 are entropy coded by the multiplexer 70 into encoded modified coefficients, to be inserted in the compressed stream.

If the macro block is of type Inter, we follow a similar approach by applying the editing operation as represented in equation (1) starting from t=t₀.

Using equation (7) in equation (8), we have:
R(t₀)=P(t₀)+E_{c}(t₀) [symbol]
R(t₀)=\tilde{R}(t₀−1)+E_{c}(t₀)
where
\overline{R}(t₀−1)=R(x+Δₓ, y+Δy, t₀−1)
is the motion compensated frame obtained using the motion vectors and the buffered frame at time t=t₀.

For all t<t₀ the prediction error frame and the motion vector are identical at both sides of the channel.

When applying an editing operation at the sender side, we need to modify the frames as:
\tilde{R}(t₀)=α(t₀)(\overline{R}(t₀−1)+E_{c}(t₀))+β(t₀) (16)
Equation 16 can be written as:
\tilde{R}(t₀)=\overline{R}(t₀−1)+(α(t₀)−1)\overline{R}(t₀−1)+α(t₀)E_{c}(t₀)+β(t₀) (17)

At the receiver side, \overline{R}(t₀−1) is obtained from the motion vectors, which we do not alter in this technique, and the previously buffered frame. Therefore, in order to get the effects at the receiver side, we need to send, or modify, the residual frame (error frame), \tilde{E}₁(t₀):
\tilde{E}_{c}(t₀)=(α(t₀)−1)\overline{R}(t₀−1)+α(t₀)E_{c}(t₀)+β(t₀) (18)
To apply the effect for any time t, equation (18) becomes:
\tilde{E}_{c}(t)=(α(t)−α(t−1))\overline{R}(t−1)+α(t)E_{c}(t)+β(t) (19)
In the DCT domain equation (19) can be written as
\tilde{e}_{c}(t)=(α(t)−α(t−1))\overline{r}(t−1)+α(t)e_{c}(t)+χ(t) (20)
where \tilde{e}_{c}(t),\overline{r}(t−1), e_{c}(t) and χ(t) are the DCT of \tilde{E}_{c}(t), \overline{R}(t−1), E_{c}(t), and β(t), respectively.

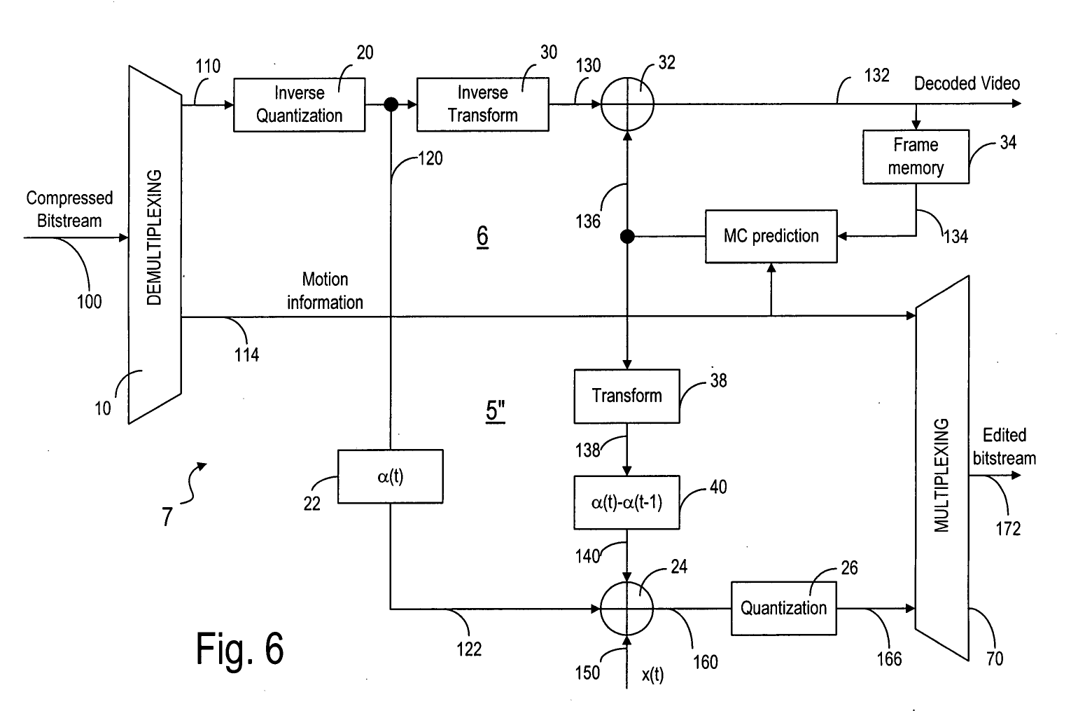

FIG. 6 illustrates how the above modifications can be implemented. The video decoder 7 as shown in FIG. 6 comprises two sections: a section 6 and a section 5″. The section 6 is a regular video decoder that uses an inverse transform block 30 to obtain from the transformed coefficients 120 the prediction error E_{c}(x,y,t) 130 and a summing device 32 to reconstruct a frame R(x, y, t) 132 by adding the predicted frame P(x, y, t) 136 in the spatial domain. The section 5 uses a transform module 38 to obtain the DCT transformation of the motion compensated reconstructed frame P(x, y, t) 136. The coefficients 138 of the motion compensated reconstructed frame in the transform domain are then scaled by a scaling module 40. The result 140 is added to the coefficients 122 of the modified residual frame in the transform domain as well as the other editing effect 150 in the transform domain. The transform coefficients 160 of the edited residual frame in the transform domain are re-quantized by a quantizer 26

The original residual frame E_{c}(t) is treated similar to what was previously presented for intra macro block. The additional required operations are the DCT transformation of the motion compensated reconstructed frame \overline{R}(t−1), and scaling of the obtained coefficients by α(t)−α(t−1). The obtained values are then quantized and entropy coded.

The following video editing operations can be performed using this technique with the described settings:

Fading-In to Black

Fading-in to a black frame V(x,y)=0 effect, for all the components of the video sequence, can be achieved using the steps described above on the luminance and chrominance components and by choosing 0<α(x,y,t)<1 and β(x,y,t)=0.

Fading-In to White

Fading-in to a white frame effect V(x,y)=2^{bitdepth}−1, which is 255 for eight-bit video, for all the components of the video sequence, can be achieved using the steps described above on the luminance and chrominance components and by choosing 1<α(x,y,t), β(x,y,t)=0.

Fading-In to an Arbitrary Color

Fading-in to a frame with an arbitrary color, V(x,y)=C, can be achieved using the steps described above on the luminance and chrominance components of the video sequence and choosing α(x,y,t) to lead to that color in the desired steps.

Fading-In to Black-and-White Frames (Monochrome Video)

Transitional fading-in to black-and-white is done by fading out the color components. This is achievable using the technique described above on the chrominance components only.

Regaining the Original Sequence after Fading-In Operations

The presented method introduces modification of the bitstream only at the residual frame level. To recover the original sequence after fading in effects, an inverse of the fading in operations is needed on the bitstream level. Using α′=α⁻¹(x,y,t) and applying the same technique would regain the original sequence. Regaining the color video sequence after applying the fading-in to black and white would require the transitional re-inclusion of the chrominance components to the bitstream.

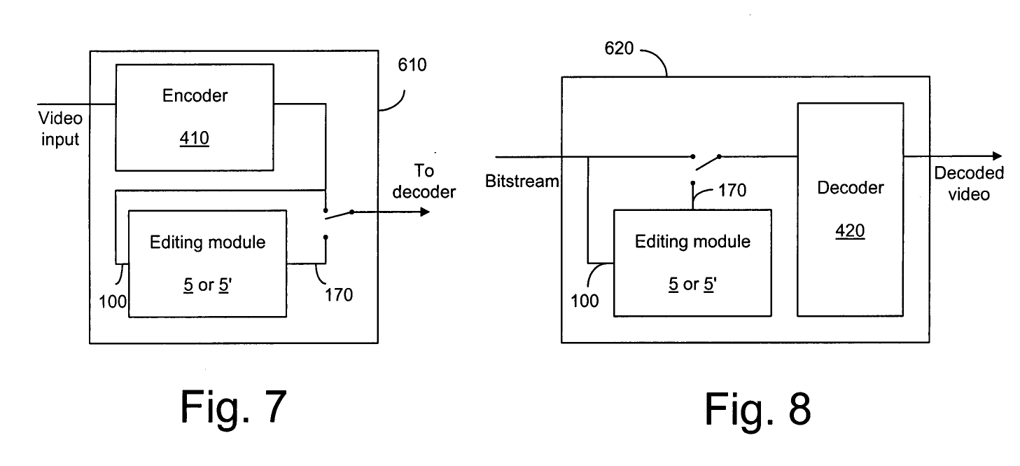

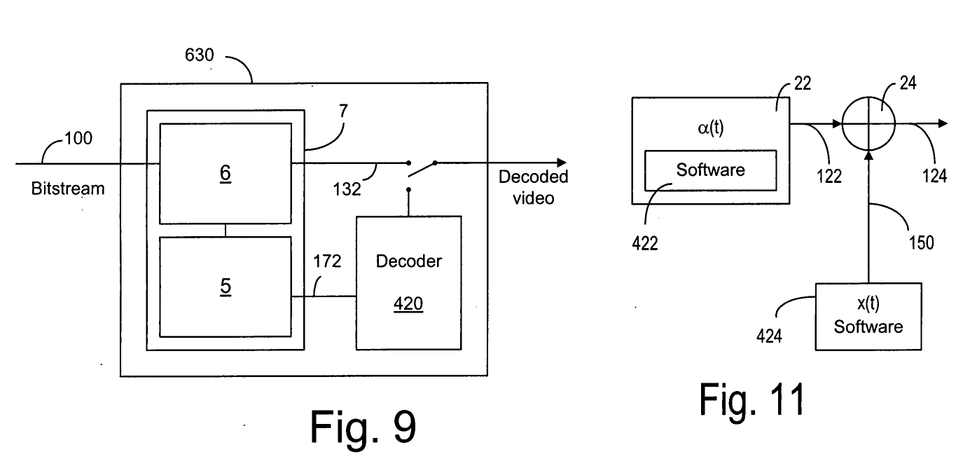

The compressed-domain editing modules 5 and 7, according to the present invention can used in conjunction with a generic video encoder or decoder, as shown in FIGS. 7 to 9. For example, the editing module 5 (FIG. 4) or module 5′ (FIG. 5) can be used in conjunction with a generic video encoder 410 to form an expanded video encoder 610, as shown in FIG. 7. The expanded encoder 610 receives video input and provides a bitstream to a decoder. As such, the expanded encoder 610 can operate like a typical encoder, or it can be used for intra frames/macro blocks compressed-domain video editing. The editing module 5 or 5′ can also be used in conjunction with a generic video decoder 420 to form an expanded video decoder 620, as shown in FIG. 8. The expanded video decoder 620 receives a bitstream containing video data and provides a decoded video signal. As such, the expanded decoder 620 can operate like a typical decoder, or it can be used for intra frames/macro blocks compressed-domain video editing. The editing module 7 (FIG. 6) can be used in conjunction with a generic decoder 420 to form another version of expanded video decoder 630. The expanded video decoder 630 receives a bitstream containing video data and provides a decoded video signal. As such, the expanded decoder 630 can operate like a typical decoder, or it can be used for inter frames/macro blocks compressed-domain video editing.

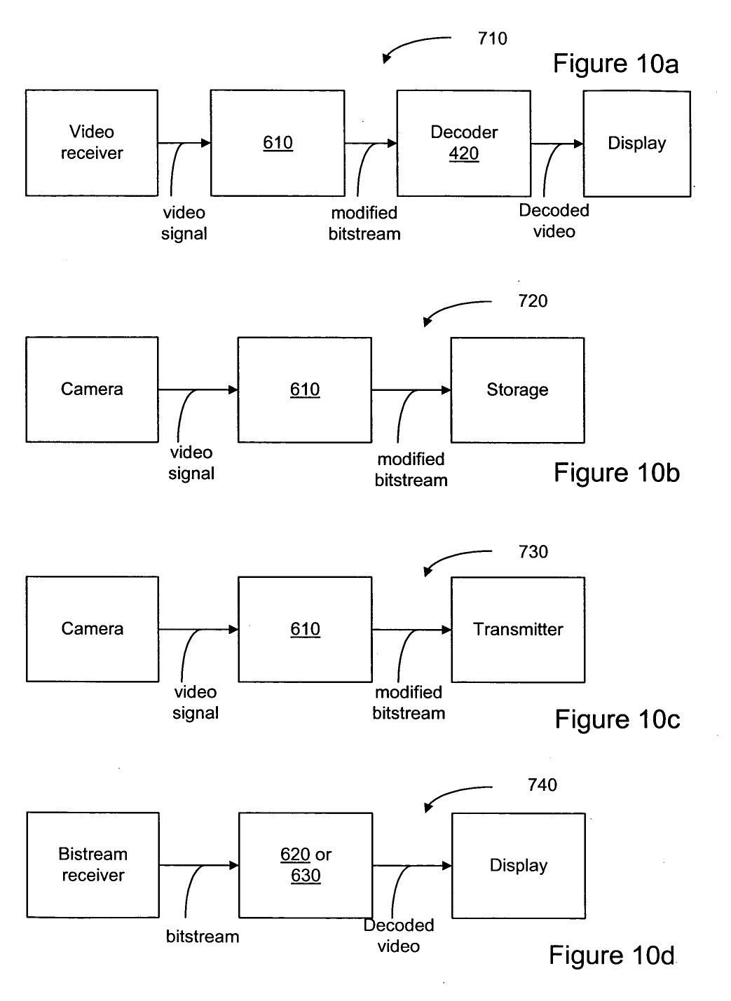

The expanded encoder 610 can be integrated into an electronic device 710, 720 or 730 to provide compressed domain video editing capability to the electronic device, as shown separately in FIGS. 10a to 10c. As shown in FIG. 10a, the electronic device 710 comprises an expanded encoder 610 to receive video input. The bistream from the output of the encoder 610 is provided to a decoder 420 so that the decoded video can be viewed on a display, for example. As shown in FIG. 10b, the electronic device 720 comprises a video camera for taking video pictures. The video signal from the video camera is conveyed to an expanded encoder 610, which is operatively connected to a storage medium. The video input from the video camera can be edited to achieve one or more video effects, as discussed previously. As shown in FIG. 10c, the electronic device 730 comprises a transmitter to transmit the bitstream from the expanded encoder 610. As shown in FIG. 10d, the electronic device 740 comprises a receiver to receive a bitstream containing video data. The video data is conveyed to an expanded decoder 620 or 630. The output from the expanded decoder is conveyed to a display for viewing. The electronic devices 710, 720, 730, 740 can be a mobile terminal, a computer, a personal digital assistant, a video recording system or the like.

It should be understood that video effect provided in block 22, as shown in FIGS. 4, 5 and 6 can be achieved by a software program 422, as shown in FIG. 11. Likewise, the additional editing effect 150 can also be achieved by another software program 424. For example, these software programs have a first code for providing editing data indicative of α(x,y,t) and a second code for applying the editing data to the transform coefficients d(x,y,t) by a multiplication operation. The second code can also have a summing operation to apply another editing data indicative of χ(t) to the transformed coefficients d(x,y,t) or the edited transformed coefficients α(x,y,t) d(x,y, t).

Although the invention has been described with respect to a preferred embodiment thereof, it will be understood by those skilled in the art that the foregoing and various other changes, omissions and deviations in the form and detail thereof may be made without departing from the scope of this invention.

1. A method of editing a bitstream carrying video data indicative of a video sequence, wherein the video data comprises residual data in the video sequence, said method comprising:
obtaining the residual data from the bitstream; and
modifying the residual data for providing further data in a modified bitstream in order to achieve a video effect.

2. The method of claim 1, wherein said modifying is carried out in a transform domain.

3. The method of claim 1, wherein the residual data is indicative of residual error data.

4. The method of claim 1, wherein the bitstream comprises a compressed bitstream, and said modifying is carried out on the compressed bitstream.

5. The method of claim 1, wherein the residual data is indicative of transformed residual error data.

6. The method of claim 1, wherein the residual data is indicative of quantized, transformed residual error data.

7. The method of claim 1, wherein the residual data is indicative of coded, quantized, transformed residual error data.

8. The method of claim 1, wherein the video effect comprises an effect of fade-in to a color.

9. The method of claim 8, wherein the color is black.

10. The method of claim 8, wherein the color is white.

11. The method of claim 1, wherein the video effect comprises an effect of fade-in from one color to another color.

12. The method of claim 1, wherein the video effect comprises an effect of fade-in from color components in color video frames to color components in monochrome video frames.

13. A video editing device for use in editing a bitstream carrying video data indicative of a video sequence, wherein the video data comprises residual data in the video sequence, said device comprising:
a first module for obtaining an error signal indicative of the residual data in transform domain from the bitstream;
a second module, responsive to the error signal, for combining editing data indicative of an editing effect with the error signal for providing a modified bitstream.

14. The editing device of claim 13, wherein the bitstream comprises a compressed bitstream, and the first module comprises an inverse quantization module for providing a plurality of transform coefficients containing the residual data.

15. The editing device of claim 14, wherein the editing data is applied to the transform coefficients for providing a plurality of edited transform coefficients in the compressed domain.

16. The editing device of claim 15, wherein the second module combines further editing data to the edited transform coefficients for achieving a further editing effect.

17. The editing device of claim 13, wherein the bitstream comprises a plurality of quantization parameters containing residual data so as to allow the editing data to be combined with the quantization parameters for providing the modified bitstream.

18. An electronic device comprising
a first module, responsive to video data indicative of a video sequence, for providing a bitstream indicative of the video data, wherein the video data comprises residual data; and
a second module, responsive to the bitstream, for combining editing data indicative of an editing effect with the error signal in transform domain for providing a modified bitstream.

19. The electronic device of claim 18, wherein the bitstream comprises a compressed bitstream, and the second module comprises an inverse quantization module for providing a plurality of transform coefficients comprising the error data.

20. The electronic device of claim 19, wherein the editing data is applied to the transform coefficients for providing a plurality of edited transform coefficients in the compressed domain.

21. The electronic device of claim 20, wherein the second module further comprises a combining module for combining further editing data to the edited transform coefficients for achieving a further editing effect.

22. The electronic device of claim 18, further comprising an electronic camera for providing a signal indicative of the video data.

23. The electronic device of claim 18, further comprising a receiver for receiving a signal indicative of the video data.

24. The electronic device of claim 18, further comprising a decoder, responsive to the modified bitstream, for providing a video signal indicative of decoded video.

25. The electronic device of claim 18, further comprising a storage medium for storing a video signal indicative of the modified bitstream.

26. The electronic device of claim 18, further comprising a transmitter for transmitting the modified bitstream.

27. A software program for use in a video editing device for editing a bitstream carrying video data indicative of a video sequence in order to achieve a video effect, wherein the video data comprises residual data in the video sequence, said software program comprising:
a first code for providing editing data indicative of the video effect; and
a second code for applying the editing data to the residual data in a transform domain for providing further data in the bitstream.

28. The software program of claim 27, wherein the second code comprises a multiplication operation for applying the editing data to the residual data.

29. The software program of claim 27, wherein the second code comprises a summing operation for applying the editing data to the residual data.

30. The software program of claim 27, wherein the editing data comprises first editing data and second editing data, and wherein the second code comprises
a multiplication operation for applying the first editing data to the residual data for providing edited residual data; and
a summing operation for applying the second editing data to the edited residual data for providing the further data.

31. The software program of claim 27, wherein the video effect comprises an effect of fade-in to a color.

32. The software program of claim 27, wherein the video effect comprises an effect of fade-in from one color to another color.
